(19) United States
(12) Patent Application Publication
(10) Pub. No.: US 2024/0062151 A1
(43) Pub. Date: Feb. 22, 2024

(54) SUPPLY CHAIN DISRUPTION PREDICTIONS

(71) Applicant: Capital One Services, LLC, McLean, VA (US)

(72) Inventors: Xiaoguang Zhu, New York, NY (US); Ray Cheng, Long Island City, NY (US); Jennifer Kwok, Brooklyn, NY (US)

(21) Appl. No.: 17/889,462

(22) Filed: Aug. 17, 2022

(51) Int. Cl. G06Q 10/08; G06Q 30/02; G06Q 30/06

(52) U.S. Cl. CPC G06Q 10/087; G06Q 30/0206; G06Q 30/0635

(57) ABSTRACT

Disclosed embodiments include aspects that relate to supply chain disruption predictions. An individual can identify a product. Product information associated with the product can be compiled and analyzed to determine the composition of the product. Raw material can be identified as part of the product's composition based on the product information analysis. Disruption data for a supply chain of the at least one raw material can be compiled and analyzed. A supply chain disruption can be identified based on the analysis of the disruption data. A transaction can be recommended to the customer based on the supply chain disruption, such as an optimized timing to purchase the product.

### BACKGROUND

Product availability can be difficult to predict due to the many factors that come into effect. Supply chains can be particularly sensitive to various factors. A supply chain for a product can include many factors such as location, weather, shipping delays, or raw materials availability. Frequently, the price and availability of a product are affected by these factors. Further, product demand affects product availability such that customers may not be able to receive the product at the needed time.

### SUMMARY

The following presents a simplified summary of the disclosure to provide a basic understanding of some aspects. This summary is not an extensive overview of the disclosure. It is not intended to identify key/critical elements of the disclosure or to delineate the scope of the disclosure. Its sole purpose is to present some concepts of the disclosure in a simplified form as a prelude to the more detailed description presented later.

According to one aspect, disclosed embodiments can include a system that comprises a processor coupled to a memory that includes instructions that, when executed by the processor, cause the processor to determine product composition for a product based on an analysis of product information associated with the product, identify a raw material from the product composition, and invoke a disruption model that predicts a material availability trend from an input raw material with the raw material identified, wherein the disruption model is a machine learning model trained with historical disruption data. The instructions can also cause the processor to identify a supply chain disruption for the raw material based on the material availability trend, determine a transaction for the product that minimizes impact of the supply chain disruption on at least one of price or availability of the product, and output the transaction for the product. Further, the instructions can cause the processor to analyze a transaction history of the product, predict a product demand trend based on the analysis of the transaction history, and account for the product demand trend when the transaction is determined. In one instance, the instructions can also cause the processor to compile the historical disruption data from at least one of a news report, shipping throughput data, consumer transaction data, or seller data. The instructions can further cause the processor to predict a price trend based on the supply chain disruption and determine a product price based on the price trend. Further, the instructions can cause the processor to collect the product information from a product source, such as an advertisement, product description, or seller website, and invoke natural language processing on the product information to determine the raw material. The instructions can also cause the processor to invoke computer vision on an image of the product to predict the product composition from the image in one instance. Further, the instructions can cause the processor to determine an upcoming transaction of a customer; identify an optimized timing of the upcoming transaction, and alter the upcoming transaction with the optimized timing.

The instructions can further cause the processor to identify a second raw material as part of a second composition of a second product, wherein the second product is fungible with the product, analyze second disruption data for a second supply chain of the second raw material, predict a second material availability trend based on the analysis of the second disruption data, identify a supply chain surplus based on the second material availability trend, and recommend the transaction as purchasing the second product based on the supply chain surplus. In one scenario, the transaction can indicate that a customer should increase the quantity of the product based on the supply chain disruption.

In accordance with another aspect, disclosed embodiments can include a method comprising executing, on a processor, instructions that cause the processor to perform operations associated with recommendation. The operations include determining product composition for a product based on an analysis of product information associated with the product, identifying a raw material from the product composition, predicting a material availability trend for the raw material by executing a disruption model that is a machine learning model trained with historical disruption data, and identifying a supply chain disruption for the raw material based on the material availability trend. The operations can further include determining a transaction for the product that minimizes impact of the supply chain disruption on at least one of price or availability of the product and outputting the transaction for the product as a recommendation. Further, the operations can comprise analyzing a transaction history of the product, predicting a product demand trend based on the analysis of the transaction history, and accounting for the product demand trend in determining the transaction. In one instance, the operations can also comprise compiling the historical disruption data from one or more data sources, such as a news report, shipping throughput data, consumer transaction data, or seller data. Determining the transaction can further comprise predicting a price trend based on identifying the supply chain disruption and offering a price of the product to a customer based on the price trend. The operations can further comprise compiling the product information from product sources, wherein the product sources include an advertisement, a product description, or a seller website, and executing natural language processing on the product information to determine the raw material. Identifying the raw material can comprise employing computer vision technology to determine the raw material from an image of the product in one embodiment. The operations can further comprise determining an upcoming transaction of a customer, identifying an optimized timing of the upcoming transaction, and altering the upcoming transaction with the optimized timing. Furthermore, the operations can comprise identifying a second raw material as part of a second composition of a second product that is fungible with the product, analyzing second disruption data for a second supply chain of the second raw material, predicting a second material availability trend based on the analysis of the second disruption data, identifying a supply chain surplus based on the second material availability trend, and recommending the transaction as purchasing the second product based on the supply chain surplus.

According to yet another aspect, disclosed embodiments can include a computer-implemented method. The method comprises receiving browsing history of an individual, identifying a product and product information from the browsing history, determining a composition of the product including at least one raw material as part of the composition of the product based on analysis of product information, and compiling disruption data for a supply chain of the at least one raw material. Further, the method can comprise predicting a material availability trend based on analysis of the disruption data, wherein the predicting comprises invoking a machine-learning-based disruption model, trained with historical disruption data, on the disruption data, identifying a supply chain disruption based on the material availability trend, and identifying a transaction based on the supply chain disruption. The computer-implemented method can further comprise analyzing a transaction history of the product, predicting a product demand trend based on the analysis of the transaction history, and accounting for the product demand trend to identify the transaction. Further, analyzing the product information can comprise compiling the product information from product sources, such as an advertisement, a product description, or a seller website, and parsing the product information with natural language processing to determine the at least one raw material.

In aspects, the subject disclosure provides substantial benefits in terms of supply chain disruption predictions. One advantage resides in a recommended transaction to a customer for purchasing a product. Another advantage resides in an optimized timing for purchasing the product to avoid a supply chain disruption.

To the accomplishment of the foregoing and related ends, certain illustrative aspects of the disclosure are described herein in connection with the following description and the annexed drawings. These aspects are indicative, however, of but a few of the various ways in which the principles of the disclosure can be employed, and the subject disclosure is intended to include all such aspects and their equivalents. Other advantages and novel features of the disclosure will become apparent from the following detailed description when considered in conjunction with the drawings.

### BRIEF DESCRIPTION OF THE DRAWINGS

Aspects of the disclosure are understood from the following detailed description when read with the accompanying drawings. Elements or structures of the drawings are not necessarily drawn to scale. Accordingly, for example, the dimensions can be arbitrarily increased or reduced for clarity of discussion.

FIG. 1 illustrates a high-level diagram of the subject disclosure according to aspects herein.

FIG. 2 illustrates an example component diagram of a supply chain analyzer.

FIG. 3 illustrates an example component diagram of a product component.

FIG. 4 illustrates an example component diagram of a disruption component.

FIG. 5 illustrates a method for supply chain disruption predictions.

FIG. 6 is a block diagram illustrating a suitable operating environment for aspects of the subject disclosure.

### DETAILED DESCRIPTION

Various aspects of the subject disclosure are now described in more detail with reference to the annexed drawings, wherein like numerals generally refer to like or corresponding elements throughout. It should be understood, however, that the drawings and detailed description relating to the drawings are not intended to limit the claimed subject matter to the particular form disclosed. Instead, the intention is to cover all modifications, equivalents, and alternatives falling within the spirit and scope of the claimed subject matter.

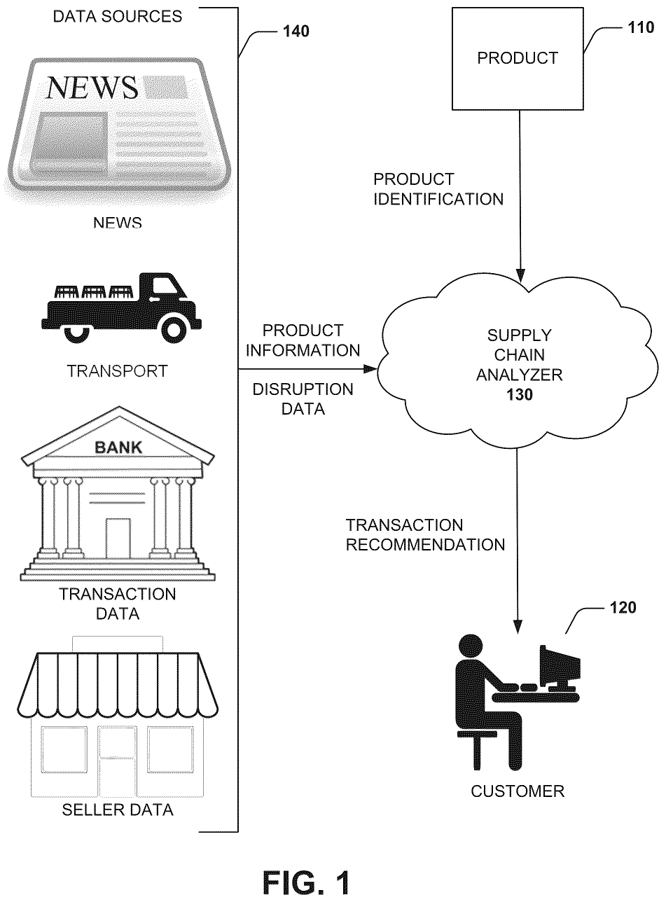

FIG. 1 illustrates a high-level view of the subject disclosure according to aspects herein. A product 110 can be identified by a customer 120 or customer device. The product 110 can be a consumer product, wholesale product, item of manufacture, or the like. The product 110 can be a product that is being considered for purchase by the customer 120. The customer 120 can be an individual, a company, business, corporation, store, or the like. The customer 120 can identify the product 110 to a supply chain analyzer 130. The supply chain analyzer 130 can be an application residing on the customer device, a cloud service application, a customer service application associated with a financial institution, or the like.

The supply chain analyzer 130 receives the product identification from the customer 120. In some embodiments, the supply chain analyzer 130 can infer that the customer 120 is considering the product 110 via analyzing a browsing history of the customer via a customer device browser. The supply chain analyzer 130 can access product sources or the data sources 140 to compile product information regarding the product 110. In some embodiments, the supply chain analyzer 130 can compile product information from product sources such as an advertisement of the product, a product description, a seller website, or the like. In some embodiments, the supply chain analyzer 130 can parse the product information via a natural language processing technique to determine the at least one raw material. For example, the product 110 can be identified as a garment. The supply chain analyzer 130 can access a seller website that includes a product description of the product 110. The supply chain analyzer 130 can analyze the seller website and the product description to determine a composition of the product 110 (e.g., what the garment is made of, such as zippers, buttons, type of fabric, or the like). The supply chain analyzer 130 can identify the raw material via a natural language processing technique of the composition of the product (e.g., the type of fabric used in the garment is cotton).

The supply chain analyzer 130 can compile disruption data regarding the raw material. Disruption data can be data that may affect the availability of the raw material. Availability of the raw material can affect the availability of the product 110. The supply chain analyzer 130 compiles disruption data from the data sources 140. The data sources 140 can include news reports, shipping throughput data, consumer transaction data, seller data, or the like. The supply chain analyzer 130 can analyze the compiled disruption data from the data sources 140. The supply chain analyzer 130 can predict a material availability trend based on analyzing the disruption data. For example, the supply chain analyzer 130 can analyze shipping throughput data from a port to determine a downward trend of raw material shipments entering a country or location of manufacture. The supply chain analyzer 130 can predict the material availability trend via a disruption model. The supply chain analyzer 130 can train the disruption model via a machine learning technique, historical disruption data, and previous supply chain disruptions to determine trends or correlations in time of year, shipping throughput, or the like. The supply chain analyzer 130 can invoke the disruption model to predict the material availability trend via the disruption data that is compiled from the data sources 140.

The supply chain analyzer 130 can identify a transaction based on the supply chain disruption, the material availability trend, or both. The supply chain analyzer 130 can determine a preferred or recommended transaction for the customer 120 to receive the product 110 while avoiding a delay due to the disruption. In some embodiments, the supply chain analyzer 130 determines an upcoming transaction of the customer 120. The supply chain analyzer 130 identifies an optimized timing of the upcoming transaction based on a predicted disruption or material availability trend. The supply chain analyzer 130 can automatically alter the upcoming transaction with the optimized timing to avoid delay due to the predicted disruption. For example, the supply chain analyzer 130 can alter an upcoming order to an earlier date to avoid the predicted disruption.

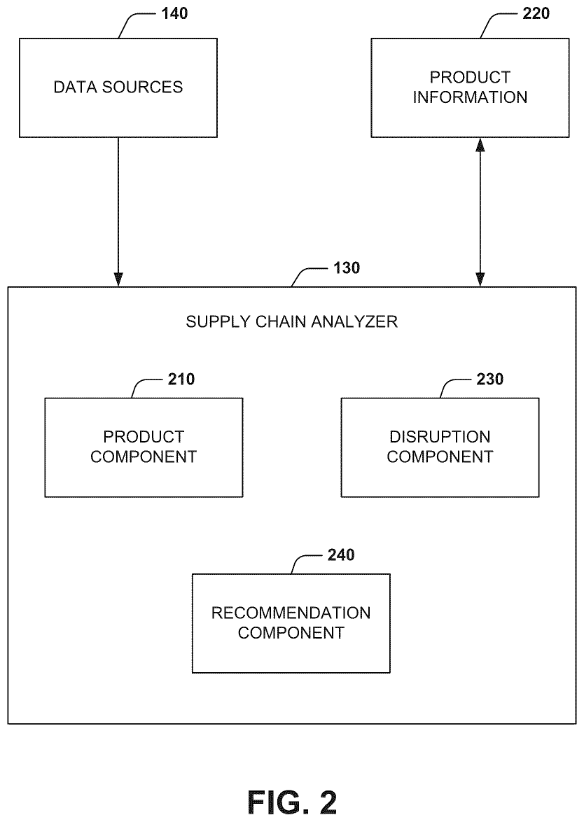

FIG. 2 illustrates a detailed component diagram of supply chain analyzer 130 in accordance with some aspects of the disclosure. The supply chain analyzer 130 includes a product component 210. The product component 210 can receive or determine a product identification based on product information 220. In some embodiments, the product component 210 can compile product information 220 to identify a product that is currently popular or in demand. The product component 210 can identify the product 110 from transaction data, news sources, retailers/sellers, review data, social media data, or the like. In some embodiments, the product component 210 can identify the product 110 via analyzing a picture of the product 110 that is received from the customer 120. The product component 210 can utilize a computer vision technique or other image analysis to identify the product 110.

In some embodiments, the product component 210 can infer that the customer 120 is considering a purchase of the product 110 via analyzing a browsing history of the customer via a customer device or installed browser. In some embodiments, the product component 210 can parse the product information via a natural language processing technique to determine at least one raw material. For example, the product 110 can be identified as an action figure toy. The product component 210 can access a seller website that includes a product description of the product 110. The product component 210 can analyze the seller website and the product description to determine a composition of the product 110 (e.g., the parts of the action figure toy). The product component 210 can identify the raw material via a natural language processing technique of the composition of the product (e.g., the type of plastic used in a part of the action figure toy).

The supply chain analyzer 130 includes a disruption component 230. The disruption component 230 can compile disruption data regarding the raw material. Disruption data can be data that may affect the availability of the raw material. Availability of the raw material can ultimately affect the availability of the product 110. The disruption component 230 can compile disruption data from the data sources 140. The data sources 140 can include news reports, shipping throughput data, consumer transaction data, seller data, or the like. News reports can include online or print articles that mention the product 110 or the raw materials. Shipping throughput data can include the number of shipments processed at shipping centers such as seaports, airports, trucking dispatches, train/rail centers, or the like. Consumer transaction data can include the rate of purchases of the product 110, raw material, timing (e.g., average, trend) between purchase and receiving the product 110 or raw material, or a combination of transaction data. Seller data can include the rate of purchases of the product 110 or raw material, number of sales, timing (e.g., average, trending rate of change) between purchase and shipping the product 110 or raw material, or the like.

In some embodiments, the disruption component 230 can utilize natural language processing techniques, website crawlers, a data mining technique, or the like to analyze the data sources 140. For example, the disruption component 230 accesses news sources regarding the product 110. The disruption component 230 can find news articles regarding the product 110, the raw material, or both from the new sources. The disruption component 230 can analyze the news sources for words or phrases that indicate a disruption via a natural language processing technique. For example, a news article can mention a ship stuck in a canal carrying a bulk shipment of the raw material or the product. The disruption component 230 can analyze the news article to determine that a delay in the shipment will lead to a supply chain disruption for the raw material or product 110.

The disruption component 230 can analyze the compiled disruption data from the data sources 140. The disruption component 230 can predict a material availability trend based on analyzing the disruption data. The disruption component 230 can predict the material availability trend via a disruption model. The disruption component 230 can train the disruption model via a machine learning technique and historical disruption data to determine trends in time of year, shipping throughput, or the like. The disruption component 230 can invoke the disruption model to predict the material availability trend via the disruption data that is compiled from the data sources 140.

The supply chain analyzer 130 includes a recommendation component 240. The recommendation component 240 can identify a transaction based on the supply chain disruption, material availability trend, or both. The recommendation component 240 can determine a preferred or recommended transaction for the customer 120 to receive the product 110 while avoiding a delay due to the disruption. In some embodiments, the recommendation component 240 determines an upcoming transaction of the customer 120. The recommendation component 240 identifies an optimized quantity of the upcoming transaction based on a predicted disruption or material availability trend. The recommendation component 240 can automatically alter the upcoming transaction with the optimized quantity to avoid delay due to the predicted disruption. For example, the recommendation component 240 can alter an upcoming order to increase a quantity of the raw material to avoid the predicted disruption.

In some embodiments, the recommendation component 240 can recommend an alternate product for purchase by the customer 120 as the transaction. In some embodiments, the alternate product or second product can be fungible with the product 110. The product component 210 can identify the second product by analyzing the product 110 and determining a fungible product as the second product. The product component 210 can determine a second raw material as part of a second composition of the second product. The disruption component 230 can compile and analyze second disruption data for a second supply chain of the second raw material. The disruption component 230 can predict a second material availability trend based on the analysis of the second disruption data. The disruption component 230 can identify a supply chain surplus or absence of a supply chain disruption based on the second material availability trend. The recommendation component 240 can recommend a transaction such as purchasing the second product instead of the product 110 based on the supply chain surplus or absence of a disruption.

In some embodiments, the recommendation component 240 can predict a price trend. The recommendation component 240 can predict the price trend based on identifying the supply chain disruption. For example, the recommendation component 240 can predict that the price of a product 110 will increase in two weeks based on a supply chain disruption and stock of the product 110 being depleted. The recommendation component 240 can offer the product 110 to the customer 120 before the price increases.

In some embodiments, the recommendation component 240 can predict a product demand trend of the product 110. The product demand trend can be factored into the recommendation for a transaction. The recommendation component 240 can access a transaction history of the product 110. The recommendation component 240 can receive the transaction history from a seller, retailer, financial institution, customer account information, or the like. The recommendation component 240 can determine a demand metric from sales data of the product 110. In some embodiments, the recommendation component 240 can calculate a sales rate from the sales data to determine a level of demand for the product 110. The recommendation component 240 can determine an optimized time (e.g., a date) to purchase the product 110 such that a supply chain disruption or delay due to low stock is avoided. For example, the recommendation component 240 analyzes the sales rate and compares it to a threshold rate. If the sales rate is above the threshold, the recommendation component 240 can determine that the customer 120 should purchase the product 110 within a time period, such as a week. If the sales rate is below the threshold, the recommendation component 240 can determine that the customer 120 can purchase the product 110 when they please.

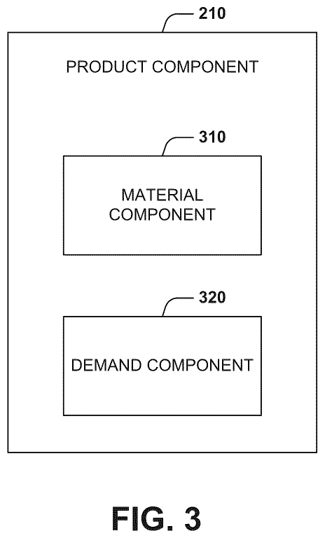

FIG. 3 illustrates a detailed component diagram of the product component 210. The product component 210 includes a material component 310. The material component 310 can receive or determine a product identification based on product information 220. In some embodiments, the material component 310 can compile product information 220 to identify raw materials of the product 110 that is currently popular. The material component 310 can identify the product 110 from transaction data, news sources, retailers/sellers, review data, social media data, or the like. In some embodiments, the material component 310 can identify the product 110 via analyzing a picture of the product 110 received from the customer 120. In some embodiments, the material component 310 can utilize a computer vision technique or other image analysis to identify the product 110.

In some embodiments, the material component 310 can analyze a browsing history of the customer 120 via a customer device and installed browser. In some embodiments, the material component 310 can parse the product information via a natural language processing technique to determine the at least one raw material. For example, the product 110 can be identified as a bedroom dresser. The material component 310 can access a seller website that includes a product description of the product 110. The material component 310 can analyze the seller website and/or the product description to determine a composition of the product 110 (e.g., the parts of the bedroom dresser). The material component 310 can identify the raw material via a natural language processing technique of the composition of the product 110 (e.g., the type of wood and metal handles of the bedroom dresser).

In some embodiments, the material component 310 determines a material model based on an analysis of the product information. The material component 310 can train the material model via product information associated with the product 110. The material component 310 can utilize a machine learning technique to determine the likelihood that a raw material is included in the composition of the product 110. The material component 310 learns from existing data to make predictions about the raw material included in the product 110. The material component 310 builds the material model from the product information (e.g., “training data set”) to make data-driven predictions or decisions expressed as outputs or assessments for raw material. The material component 310 can determine the trends and/or correlations within the product information to determine raw materials. In some embodiments, the material component 310 utilizes the machine learning technique to analyze the transaction data and/or product information across different products, locations, or the like to determine a material model based on correlations in the product information. For example, the material model can determine a trend between a raw material and a manufacturer. The material component 310 can receive a product identification as an input for the material model. The material component 310 via the material model can output a composition of raw materials that most likely make up the product 110.

The product component 210 can include a demand component 320. The demand component 320 can predict a product demand trend of the product 110. The product demand trend can be factored into the recommendation for a transaction. The demand component 320 can access a transaction history of the product 110. The demand component 320 can receive the transaction history from a seller, retailer, a financial institution, customer account information, or the like. The demand component 320 can determine a demand metric from sales data of the product 110. In some embodiments, the demand component 320 can calculate a sales rate from the sales data to determine a level of demand for the product 110. The demand component 320 can determine an optimized time (e.g., a date) to purchase the product 110 such that a supply chain disruption or delay due to low stock is avoided. For example, the demand component 320 analyzes the sales rate and compares it to a threshold rate. If the sales rate is above the threshold, the demand component 320 can determine that the customer 120 should purchase the product 110 within a present time period (e.g., within a week). If the sales rate is below the threshold, the demand component 320 can determine that the customer 120 should wait to purchase the product 110 at their convenience.

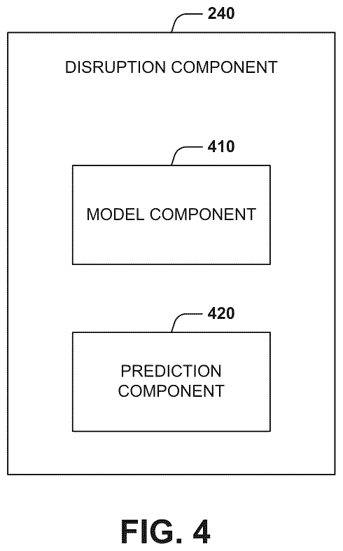

FIG. 4 illustrates a component diagram of the disruption component 230. The disruption component 230 includes a model component 410. The model component 410 can receive or compile disruption data regarding the raw material. The model component 410 compiles disruption data from the data sources 140. The data sources 140 can include news reports, shipping throughput data, consumer transaction data, seller data, or the like. News reports can include online or print articles that mention the product 110 and/or the raw materials. Shipping throughput data can include the number or amount of shipments processed at shipping centers such as seaports, airports, trucking dispatches, train/rail centers, and/or the like. Consumer transaction data can include rate of purchases of the product 110 and/or raw material, timing (e.g., average, trend, or the like) between purchase and receiving the product 110 and/or raw material, and/or the like. Seller data can include rate of purchases of the product 110 and/or raw material, number of sales, timing (e.g., average, trending rate of change, or the like) between purchase and shipping the product 110 and/or raw material or the like.

In some embodiments, the model component 410 can utilize natural language processing techniques, website crawler technique, a data mining technique, or the like to analyze the data sources 140. For example, the model component 410 accesses news sources regarding the product 110. The model component 410 can find news articles regarding the product 110 and/or the raw material from the new sources. The model component 410 can analyze the news sources for words or phrases that indicate a disruption via a natural language processing technique. For example, a news article can report a labor strike at a processing plant that processes the raw material. The model component 410 can analyze the news article to determine that a delay in processing the raw material will cause a supply chain disruption for the raw material and/or product 110.

The model component 410 can analyze the compiled disruption data from the data sources 140. The model component 410 can predict a material availability trend by analyzing the disruption data. The model component 410 can predict the material availability trend via a disruption model. The model component 410 can train the disruption model via a machine learning technique and historical disruption data to determine trends in time of year, shipping throughput, and/or the like. The model component 410 can invoke the disruption model to predict the material availability trend via the disruption data that is compiled from the data sources 140.

The model component 410 can determine a disruption model based on analysis of transaction data and/or line item data. The model component 410 can train the disruption model via the compiled disruption data associated with the raw material and/or the product 110. The model component 410 can utilize a machine learning technique to determine trends between shipping, availability, present stock quantity, product type, demand, and/or other disruption data across a plurality of products. The model component 410 can learn from existing product information to predict supply chain disruptions to the product 110 and/or raw material. The model component 410 can build the disruption model from the disruption data (e.g., “training data set”) to make data-driven predictions or decisions expressed as outputs or assessments for the product 110 and/or raw material. The model component 410 can determine the trends and/or correlations within the disruption data. For example, a correlation between severe weather in the country of a manufacturer and the timing of a supply chain disruption of the manufacturer can be determined from the training data set. The model component 410 can receive a product identification and/or a raw material and present disruption data as an input for the material model and predict a supply chain disruption based on learned correlations between historical disruption data and previous supply chain disruptions.

The disruption component 230 includes a prediction component 420. The prediction component 420 can identify a transaction based on the supply chain disruption and/or the material availability trend. The prediction component 420 can determine a preferred or recommended transaction for the customer 120 to receive the product 110 while avoiding a delay due to the disruption. In some embodiments, the prediction component 420 can determine an upcoming transaction of the customer 120. The prediction component 420 can identify an optimized quantity of the upcoming transaction based on a predicted disruption and/or material availability trend. The prediction component 420 can automatically alter the upcoming transaction with the optimized quantity to avoid delay due to the predicted disruption. For example, the prediction component 420 can alter an upcoming order to increase a quantity of the raw material to avoid the predicted disruption.

In some embodiments, the prediction component 420 can predict an alternate product for purchase by the customer 120 as the transaction. In some embodiments, the alternate product or second product can be fungible with the product 110. The prediction component 420 can identify the second product based on analyzing the product 110 and predicting a fungible product as the second product. The prediction component 420 can determine a second raw material as part of a second composition of the second product. The prediction component 420 can compile and analyze second disruption data for a second supply chain of the second raw material. The prediction component 420 can predict a second material availability trend based on the analysis of the second disruption data. The prediction component 420 can identify a supply chain surplus or absence of a supply chain disruption based on the second material availability trend. The prediction component 420 can recommend a transaction such as purchasing the second product instead of the product 110 based on the supply chain surplus or absence of a disruption.

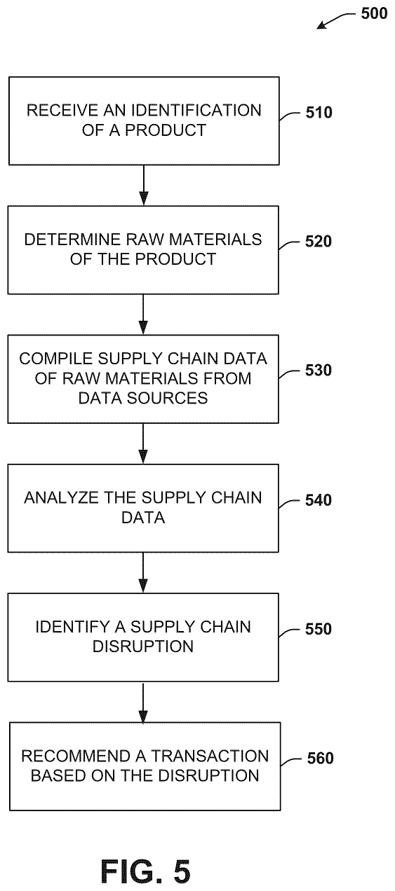

With reference to FIG. 5, example method 500 is depicted for supply chain disruption predictions. While, for purposes of simplicity of explanation, the one or more methodologies shown herein, e.g., in the form of a flow chart, are shown and described as a series of acts, it is to be understood and appreciated that the subject disclosure is not limited by the order of acts, as some acts may, in accordance with the disclosure, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosure. It is also appreciated that the method 500 is described in conjunction with a specific example for explanation purposes.

FIG. 5 illustrates a method 500 for supply chain disruption predictions. The method 500 can begin at step 510 by receiving an identification of a product. The supply chain analyzer 130 can receive a product identification from a customer 120. In other embodiments, the supply chain analyzer 130 can identify the product 110 via analyzing a customer browsing history, searches, conversations, correspondence, and/or the like. At step 520, raw materials of the product can be determined. The supply chain analyzer 130 can analyze product information associated with the product 110 to determine a composition of raw materials that make up the product 110. For example, a product 110 is identified as a build-at-home cabinet kit from a manufacturer in Sweden. The supply chain analyzer 130 can analyze a website listing of the product 110 on the manufacturer website for raw materials. The supply chain analyzer 130 can find a parts list of the kit as the raw materials, such as A-type joints, B-type screws, C-type wood panels, and/or the like. The supply chain analyzer 130 can further identify what materials the parts list is composed of, such as a metal that the B-type screws are composed of, or the like.

At step 530, supply chain data of the raw materials can be compiled. The supply chain analyzer 130 can access the data sources 140 to determine supply chain data of the raw materials. The supply chain analyzer 130 can access a weather report, news report, seller data, transaction data, transportation data, and/or the like. Continuing the example, the supply chain analyzer 130 can compile a weather report that states that shipping delays are due to an extreme snowstorm in Sweden. The supply chain analyzer 130 can further compile a news report stating that a manufacturer of A-type joints is filing for bankruptcy. At step 540, the supply chain data is analyzed. The supply chain analyzer 130 can parse the data sources that were compiled. In the example, the supply chain analyzer 130 can analyze the news report and/or weather report to determine if a supply chain disruption will occur as a consequence of the circumstances of the reports. At step 550, a supply chain disruption can be identified. The supply chain analyzer 130 can determine from the analysis that a supply chain disruption will affect the product 110 being available due to a lack of raw materials and/or product transportation. In the example, the supply chain analyzer 130 can factor product demand, current stock of the raw materials and/or completed products with the manufacturer, type of report, or the like into determining when a supply chain disruption will occur. The supply chain analyzer 130 can determine that the weather report and the news report will result in a shortage of the product 110 in three months. At step 560, a transaction can be recommended to the customer. The supply chain analyzer 130 can determine an optimal transaction regarding the product 110 to the customer 120. Continuing the example, the supply chain analyzer 130 can determine a shortage of the product 110 starting in three months. The supply chain analyzer 130 can determine that the customer 120 purchase the product 110 in the next three months before the supply chain disruption affects price, availability or both.

As used herein, the terms “component” and “system,” as well as various forms thereof (e.g., components, systems, sub-systems) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

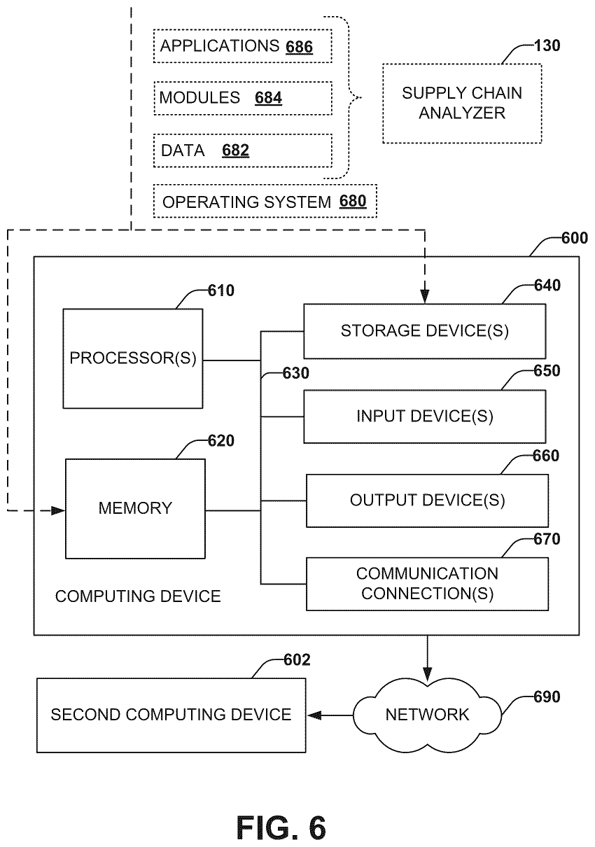

To provide a context for the disclosed subject matter, FIG. 6, as well as the following discussion, are intended to provide a brief, general description of a suitable environment in which various aspects of the disclosed subject matter can be implemented. The suitable environment, however, is solely an example and is not intended to suggest any limitation as to scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices that are linked through a communications network. However, some, if not all aspects, of the disclosed subject matter can be practiced on stand-alone computers. In a distributed computing environment, program modules may be located in one or both of local and remote memory devices.

With reference to FIG. 6, illustrated is an example computing device 600 (e.g., desktop, laptop, tablet, watch, server, hand-held, programmable consumer or industrial electronics, set-top box, game system, compute node . . . ). The computing device 600 includes one or more processor(s) 610, memory 620, system bus 630, storage device(s) 640, input device(s) 650, output device(s) 660, and communications connection(s) 670. The system bus 630 communicatively couples at least the above system constituents. However, the computing device 600, in its simplest form, can include one or more processors 610 coupled to memory 620, wherein the one or more processors 610 execute various computer executable actions, instructions, and or components stored in the memory 620.

The processor(s) 610 can be implemented with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 610 may also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 610 can be a graphics processor unit (GPU) that performs calculations with respect to digital image processing and computer graphics.

The computing device 600 can include or otherwise interact with a variety of computer-readable media to facilitate control of the computing device to implement one or more aspects of the disclosed subject matter. The computer-readable media can be any available media that is accessible to the computing device 600 and includes volatile and non-volatile media, and removable and non-removable media. Computer-readable media can comprise two distinct and mutually exclusive types, namely storage media and communication media.

Storage media includes volatile and non-volatile, removable, and non-removable media implemented in any method or technology for storing information such as computer-readable instructions, data structures, program modules, or other data. Storage media includes storage devices such as memory devices (e.g., random access memory (RAM), read-only memory (ROM), electrically erasable programmable read-only memory (EEPROM), magnetic storage devices (e.g., hard disk, floppy disk, cassettes, tape), optical disks (e.g., compact disk (CD), digital versatile disk (DVD)), and solid state devices (e.g., solid state drive (SSD), flash memory drive (e.g., card, stick, key drive)), or any other like mediums that store, as opposed to transmit or communicate, the desired information accessible by the computing device 600. Accordingly, storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 620 and storage device(s) 640 are examples of computer-readable storage media. Depending on the configuration and type of computing device, the memory 620 may be volatile (e.g., random access memory (RAM)), non-volatile (e.g., read only memory (ROM), flash memory), or some combination of the two. By way of example, the basic input/output system (BIOS), including basic routines to transfer information between elements within the computing device 600, such as during start-up, can be stored in non-volatile memory, while volatile memory can act as external cache memory to facilitate processing by the processor(s) 610, among other things.

The storage device(s) 640 include removable/non-removable, volatile/non-volatile storage media for storing vast amounts of data relative to the memory 620. For example, storage device(s) 640 include, but are not limited to, one or more devices such as a magnetic or optical disk drive, floppy disk drive, flash memory, solid-state drive, or memory stick.

Memory 620 and storage device(s) 640 can include, or have stored therein, operating system 680, one or more applications 686, one or more program modules 684, and data 682. The operating system 680 acts to control and allocate resources of the computing device 600. Applications 686 include one or both of system and application software and can exploit management of resources by the operating system 680 through program modules 684 and data 682 stored in the memory 620 and/or storage device(s) 640 to perform one or more actions. Accordingly, applications 686 can turn a general-purpose computer 600 into a specialized machine in accordance with the logic provided thereby.

All or portions of the disclosed subject matter can be implemented using standard programming and/or engineering techniques to produce software, firmware, hardware, or any combination thereof to control the computing device 600 to realize the disclosed functionality. By way of example and not limitation, all or portions of the supply chain analyzer 130 can be, or form part of, the application 686, and include one or more modules 684 and data 682 stored in memory and/or storage device(s) 640 whose functionality can be realized when executed by one or more processor(s) 610.

In accordance with one particular embodiment, the processor(s) 610 can correspond to a system on a chip (SOC) or like architecture including, or in other words integrating, both hardware and software on a single integrated circuit substrate. Here, the processor(s) 610 can include one or more processors as well as memory at least similar to the processor(s) 610 and memory 620, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the supply chain analyzer 130 and/or functionality associated therewith can be embedded within hardware in a SOC architecture.

The input device(s) 650 and output device(s) 660 can be communicatively coupled to the computing device 600. By way of example, the input device(s) 650 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 660, by way of example, can correspond to a display device (e.g., liquid crystal display (LCD), light emitting diode (LED), plasma, organic light-emitting diode display (OLED)), speakers, voice user interface system, printer, and vibration motor, among other things. The input device(s) 650 and output device(s) 660 can be connected to the computing device 600 by way of wired connection (e.g., bus), wireless connection (e.g., Wi-Fi, Bluetooth), or a combination thereof.

The computing device 600 can also include communication connection(s) 670 to enable communication with at least a second computing device 602 by means of a network 690. The communication connection(s) 670 can include wired or wireless communication mechanisms to support network communication. The network 690 can correspond to a local area network (LAN) or a wide area network (WAN) such as the Internet. The second computing device 602 can be another processor-based device with which the computing device 600 can interact. For example, the computing device 600 can correspond to a server that executes functionality of the supply chain analyzer 130, and the second computing device 602 can be a user device that communicates and interacts with the computing device 600.

What has been described above includes examples of aspects of the claimed subject matter. It is, of course, not possible to describe every conceivable combination of components or methods for purposes of describing the claimed subject matter. However, one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to a memory that includes instructions that, when executed by the processor, cause the processor to:
determine product composition for a product based on an analysis of product information associated with the product;
identify a raw material from the product composition;
invoke a disruption model that predicts a material availability trend from an input raw material with the raw material identified, wherein the disruption model is a machine learning model trained with historical disruption data;
identify a supply chain disruption for the raw material based on the material availability trend;
determine a transaction for the product that minimizes impact of the supply chain disruption on at least one of price or availability of the product; and
output the transaction for the product.

2. The system of claim 1, wherein the instructions further cause the processor to:
analyze a transaction history of the product;
predict a product demand trend based on analysis of the transaction history; and
account for the product demand trend when the transaction is determined.

3. The system of claim 1, wherein the instructions further cause the processor to compile the historical disruption data from at least one of a news report, shipping throughput data, consumer transaction data, or seller data.

4. The system of claim 1, wherein the instructions further cause the processor to:
predict a price trend based on the supply chain disruption; and
determine a product price based on the price trend.

5. The system of claim 1, wherein the instructions further cause the processor to:
collect the product information from a product source, wherein the product source includes at least one of an advertisement, product description, or seller website; and
invoke natural language processing on the product information to determine the raw material.

6. The system of claim 1, wherein the instructions further cause the processor to invoke computer vision on an image of the product to predict the product composition from the image.

7. The system of claim 1, wherein the instructions further cause the processor to:
determine an upcoming transaction of a customer;
identify an optimized timing of the upcoming transaction; and
alter the upcoming transaction with the optimized timing.

8. The system of claim 1, wherein the instructions further cause the processor to:
identify a second raw material as part of a second composition of a second product, wherein the second product is fungible with the product;
analyze second disruption data for a second supply chain of the second raw material;
predict a second material availability trend based on the analysis of the second disruption data;
identify a supply chain surplus based on the second material availability trend; and
recommend the transaction as purchasing the second product based on the supply chain surplus.

9. The system of claim 1, wherein the transaction is for a customer to increase a quantity of the product based on the supply chain disruption.

10. A method, comprising:
executing, on a processor, instructions that cause the processor to perform operations associated with recommendation, the operations comprising:
determining product composition for a product based on an analysis of product information associated with the product;
identifying a raw material from the product composition;
predicting a material availability trend for the raw material by executing a disruption model, wherein the disruption model is a machine learning model trained with historical disruption data;
identifying a supply chain disruption for the raw material based on the material availability trend;
determining a transaction for the product that minimizes impact of the supply chain disruption on at least one of price or availability of the product; and
outputting the transaction for the product as a recommendation.

11. The method of claim 10, wherein the operations further comprise:
analyzing a transaction history of the product;
predicting a product demand trend based on analysis of the transaction history; and
accounting for the product demand trend in determining the transaction.

12. The method of claim 10, wherein the operations further comprise compiling the historical disruption data from one or more data sources, wherein the one or more data sources include a news report, shipping throughput data, consumer transaction data, or seller data.

13. The method of claim 10, wherein determining the transaction further comprises:
predicting a price trend based on identifying the supply chain disruption; and
offering a price of the product to a customer based on the price trend.

14. The method of claim 10, wherein the operations further comprise:
compiling the product information from product sources, wherein the product sources include an advertisement, a product description, or a seller website; and
executing natural language processing on the product information to determine the raw material.

15. The method of claim 10, wherein identifying the raw material further comprises employing computer vision technology to determine the raw material from an image of the product.

16. The method of claim 10, the operations further comprising:
determining an upcoming transaction of a customer;
identifying an optimized timing of the upcoming transaction; and
altering the upcoming transaction with the optimized timing.

17. The method of claim 10, the operations further comprising:
identifying a second raw material as part of a second composition of a second product, wherein the second product is fungible with the product;
analyzing second disruption data for a second supply chain of the second raw material;
predicting a second material availability trend based on the analysis of the second disruption data;
identifying a supply chain surplus based on the second material availability trend; and
recommending the transaction as purchasing the second product based on the supply chain surplus.

18. A computer-implemented method, comprising:
receiving browsing history of an individual;
identifying a product and product information from the browsing history;
determining a composition of the product, wherein the composition includes at least one raw material as part of the composition of the product based on analysis of product information;
compiling disruption data for a supply chain of the at least one raw material;
predicting a material availability trend based on analysis of the disruption data, wherein the predicting comprises invoking a machine-learning-based disruption model, trained with historical disruption data, on the disruption data;
identifying a supply chain disruption based on the material availability trend; and
identifying a transaction based on the supply chain disruption.

19. The computer-implemented method of claim 18, further comprising:
analyzing a transaction history of the product;
predicting a product demand trend based on the analysis of the transaction history; and
accounting for the product demand trend to identify the transaction.

20. The computer-implemented method of claim 18, wherein analyzing the product information further comprising:
compiling the product information from product sources, wherein the product sources include an advertisement, a product description, or a seller website; and
parsing the product information with a natural language processing technique to determine the at least one raw material.
